(19) United States
(12) Patent Application Publication
(10) Pub. No.: US 2024/0378804 A1
(43) Pub. Date: Nov. 14, 2024

(54) IMAGING PLANNING DEVICE AND IMAGING PLANNING METHOD

(71) Applicant: Mitsubishi Electric Corporation, Tokyo (JP)

(72) Inventors: Kento YAMAZAKI, Tokyo (JP); Kohei OKAHARA, Tokyo (JP); Yoshihiro TOMARU, Tokyo (JP); Momoyo HINO, Tokyo (JP)

(73) Assignee: Mitsubishi Electric Corporation, Tokyo (JP)

(21) Appl. No.: 18/783,177

(22) Filed: Jul. 24, 2024

Related U.S. Application Data
(63) Continuation of application No. PCT/JP2022/006287, filed on Feb. 17, 2022.

(51) Int. Cl. G06T 17/00

(52) U.S. Cl. CPC G06T 17/00

(57) ABSTRACT

An imaging planning method includes: applying a virtual solid figure having a predetermined shape to a virtual object imitating a shape of a solid object for which a three-dimensional model is to be generated; performing repetition of arrangement of positions of virtual cameras based on a position on a surface of the virtual solid figure, imaging of the virtual object by the virtual cameras after the arrangement, and an increase in the number of the virtual cameras; determining the number and positions of the virtual cameras required to acquire of virtual images regarding the virtual object required to generate a three-dimensional model of the virtual object through the repetition; and planning, based on the number and the positions of the virtual cameras, the number and positions of cameras required to acquire images regarding the solid object that are to be required to generate the three-dimensional model of the solid object.

### CROSS REFERENCE TO RELATED APPLICATION

This application is a Continuation of PCT International Application No. PCT/JP2022/006287, filed on Feb. 17, 2022, which is hereby expressly incorporated by reference into the present application.

### TECHNICAL FIELD

The present disclosure relates to an imaging planning device and an imaging planning method.

### BACKGROUND ART

One of objects of an imaging planning method for generating a three-dimensional model disclosed in Non-Patent Literature 1 is to solve a problem that might occur in a case where the three-dimensional model is generated from a plurality of images imaged by cameras using structure from motion (SfM) and multi-view stereo (MVS). Specifically, the above-described problem is that it is not possible to correctly estimate a pose of a camera because positions and the number of the plurality of imaged images are not appropriate, and it takes a lot of processing time for the above-described MVS when trying to avoid occurrence of a large error and the like in the generated three-dimensional model.

### CITATION LIST

### Non-Patent Literature

Non-Patent Literature 1: Ryota Moritani, “Development of high-precision modeling and optimum view planning methods for 3D as-is model reconstruction of large-scale structures”, 2021

### SUMMARY OF INVENTION

### Technical Problem

In the imaging planning method described above, in order to achieve the above-described object, and to improve a low-quality region of the three-dimensional model, a pose of a camera that should add imaging is estimated, and additional imaging is actually performed. Therefore, there has been a problem that it takes a lot of time for the additional imaging if accuracy of estimating the pose of the camera to be added is not high.

An object of the present disclosure is to provide an imaging planning device and an imaging planning method capable of planning estimation of a pose of a camera for additional imaging performed to complete a three-dimensional model with higher accuracy while allowing the processing of at least one of SfM and MVS to be performed.

### Solution to Problem

In order to solve the above-described problem, an imaging planning device according to the present disclosure includes processing circuitry to apply a virtual solid figure having a predetermined shape to a virtual model object imitating a shape of a solid object for which a three-dimensional model is to be generated, to perform repetition of arrangement of a position of at least one virtual camera on a basis of a position on a surface of the virtual solid figure, imaging of the virtual model object by the at least one virtual camera at a position after the arrangement, and an increase in the number of the at least one virtual camera, to determine the number and positions of the at least one virtual camera required to acquire a plurality of virtual images regarding the virtual model object required to generate a three-dimensional model of the virtual model object obtained by the repetition, and to plan, on a basis of the number and the positions of the at least one virtual camera, the number and positions of cameras required to acquire a plurality of images regarding the solid object that are to be required to generate the three-dimensional model of the solid object.

### Advantageous Effects of Invention

According to the imaging planning device according to the present disclosure, it is possible to plan estimation of a pose of the camera for additional imaging performed to complete the three-dimensional model with higher accuracy.

### BRIEF DESCRIPTION OF DRAWINGS

FIG. 1 is a functional block diagram of an imaging planning device SKS of a first embodiment.

FIG. 2 illustrates an actual solid object RI of the first embodiment.

FIG. 3 illustrates a virtual model object MO of the first embodiment.

FIG. 4 illustrates a virtual solid figure RZ of the first embodiment.

FIG. 5 illustrates a hardware configuration of the imaging planning device SKS of the first embodiment.

FIG. 6 is a flowchart illustrating an operation of the imaging planning device SKS of the first embodiment.

FIG. 7 illustrates an operation of applying the solid figure RZ to the model object MO of the first embodiment.

FIG. 8 illustrates operations of arranging, imaging, and extracting in the imaging planning device SKS of the first embodiment (1).

FIG. 9 illustrates operations of arranging, imaging, and extracting in the imaging planning device SKS of the first embodiment (2).

FIG. 10 illustrates operations of arranging, imaging, and extracting in the imaging planning device SKS of the first embodiment (3).

FIG. 11 illustrates operations of arranging, imaging, and extracting in the imaging planning device SKS of the first embodiment (4).

FIG. 12 illustrates operations of arranging, imaging, and extracting in the imaging planning device SKS of the first embodiment (5).

FIG. 13 is a functional block diagram of an imaging planning device SKS of a second embodiment.

FIG. 14 illustrates a virtual part BU of the second embodiment.

FIG. 15 illustrates a solid figure RZ of the second embodiment.

FIG. 16 illustrates an operation of an imaging planning device SKS of a third embodiment.

### DESCRIPTION OF EMBODIMENTS

An embodiment of an imaging planning device according to the present disclosure will be described.

### First Embodiment

### First Embodiment

An imaging planning device SKS of a first embodiment will be described.

Hereinafter, in order to facilitate description and understanding, one reference sign sometimes collectively refers to a plurality of names. For example, a reference sign “camera KA” sometimes collectively refers to “cameras KAa, KAb and the like”.

### Function of First Embodiment

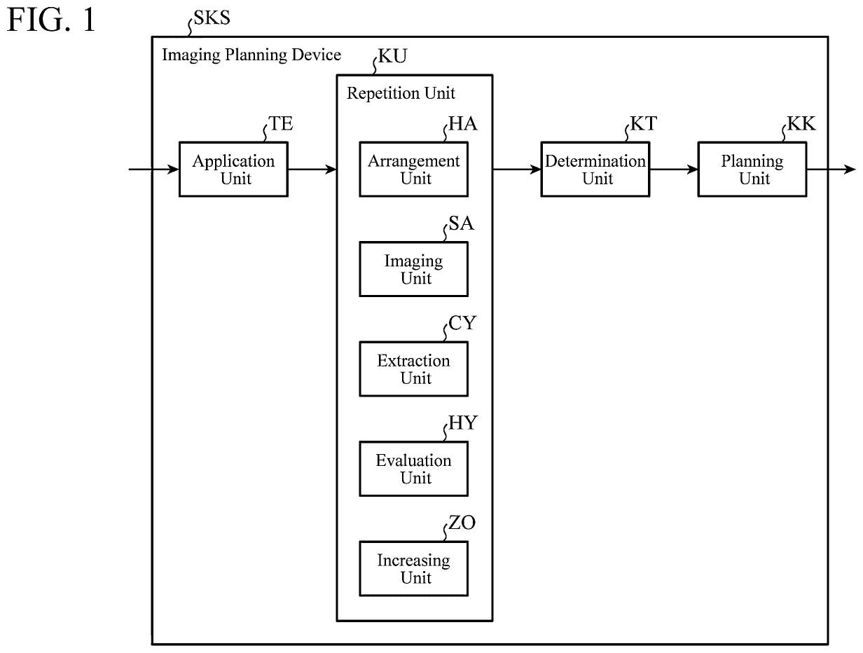

FIG. 1 is a functional block diagram of the imaging planning device SKS of the first embodiment.

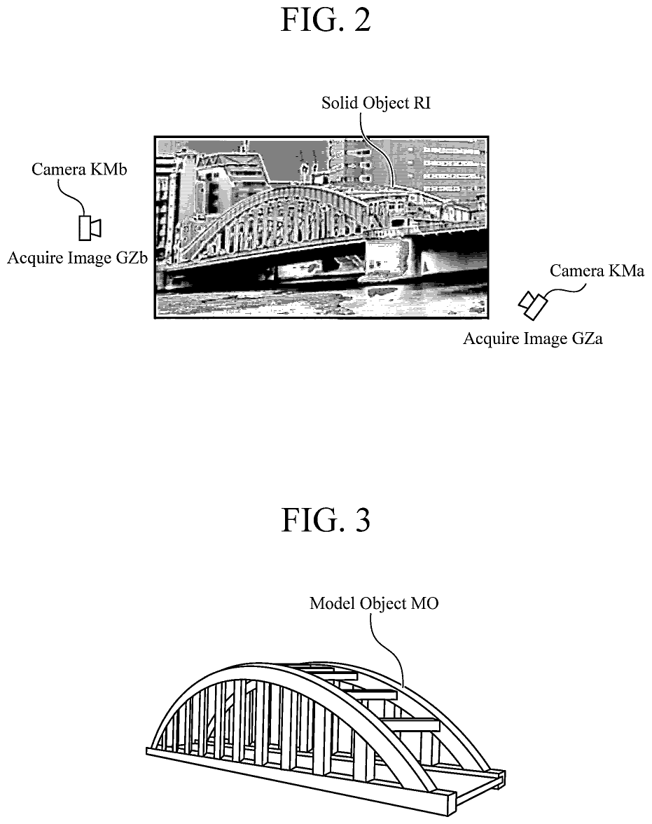

FIG. 2 illustrates an actual solid object RI of the first embodiment.

FIG. 3 illustrates a virtual model object MO of the first embodiment.

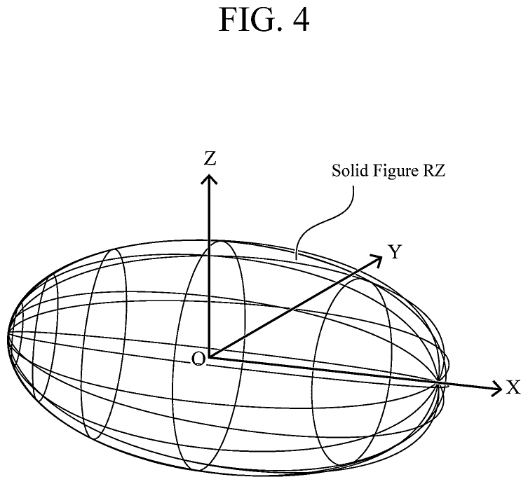

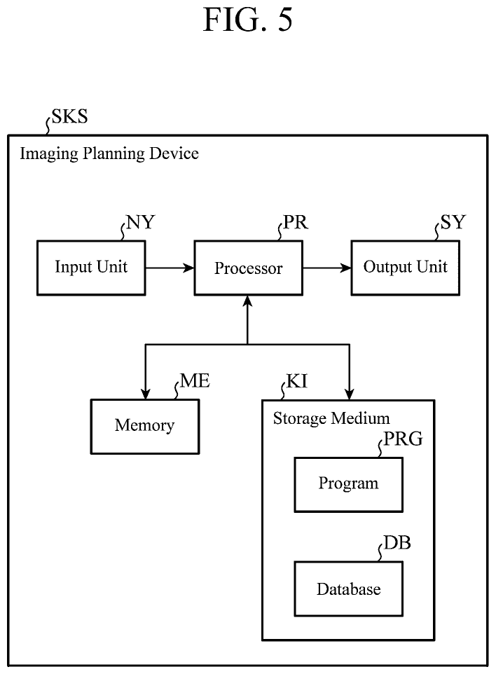

FIG. 4 illustrates a virtual solid figure RZ of the first embodiment.

A function of the imaging planning device SKS of the first embodiment will be described with reference to FIGS. 1 to 4.

The imaging planning device SKS of the first embodiment includes an application unit TE, a repetition unit KU, a determination unit KT, and a planning unit KK as illustrated in FIG. 1.

The application unit TE corresponds to an “application unit”, the repetition unit KU corresponds to a “repetition unit”, the determination unit KT corresponds to a “determination unit”, and the planning unit KK corresponds to a “planning unit”.

The application unit TE applies the virtual solid figure RZ (illustrated in FIG. 4) having a predetermined shape to the virtual model object MO (illustrated in FIG. 3) that simulates a shape of the actual solid object RI (illustrated in FIG. 2) for which a three-dimensional model is to be generated.

Hereinafter, the actual solid object RI is abbreviated as a “solid object RI”, the virtual model object MO is abbreviated as a “model object MO”, and the virtual solid figure RZ is abbreviated as a “solid figure RZ”.

The solid object RI is an existing artificial object, natural object and the like, such as a bridge (illustrated in FIG. 2), a building, a forest, and a river, for example.

As described above, the model object MO imitates the shape of the solid object RI, and is present on a computer or a computer network. The model object MO is, for example, a model of a bridge as illustrated in FIG. 3.

As described above, the solid figure RZ has a predetermined shape, and is present on the computer or the computer network similarly to the model object MO. The solid figure RZ is, for example, an ellipsoid (illustrated in FIG. 4).

The repetition unit KU includes an arrangement unit HA, an imaging unit SA, an extraction unit CY, an evaluation unit HY, and an increasing unit ZO as illustrated in FIG. 1.

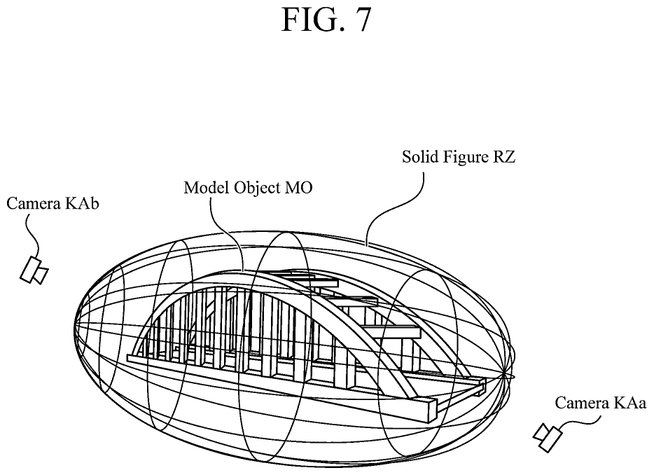

The arrangement unit HA arranges virtual cameras KAa and KAb (for example, illustrated in FIG. 7) for imaging the model object MO on the basis of a position on a surface of the solid figure RZ, and more accurately, changes positions thereof.

Hereinafter, for example, the virtual camera KAa is abbreviated as a “camera KAa”, and other virtual cameras are similarly abbreviated.

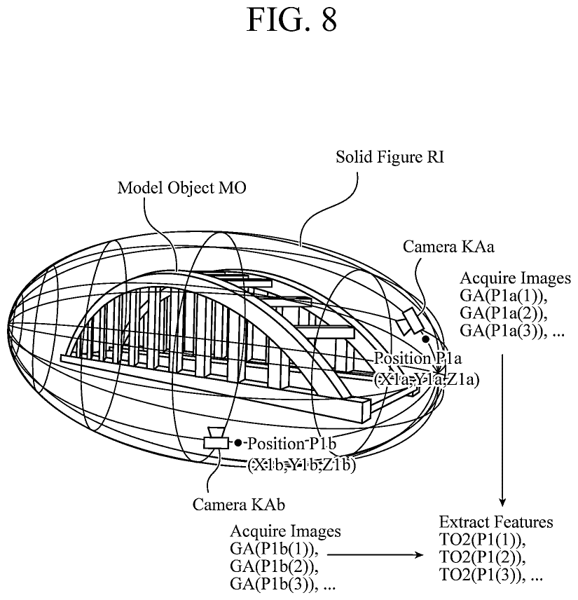

The imaging unit SA acquires a plurality of virtual images GA (for example, illustrated in FIG. 8) by imaging the model object MO using the cameras KAa, KAb and the like the positions of which are changed by the arrangement unit HA.

Hereinafter, the virtual image GA is abbreviated as an “image GA”.

The extraction unit CY extracts a plurality of features TO (for example, illustrated in FIG. 8) from the plurality of images GA acquired by the imaging unit SA. Herein, the feature TO is a point used for generating a three-dimensional model of the model object MO as conventionally known.

The evaluation unit HY performs evaluation of the plurality of images GA acquired by the imaging unit SA on the basis of the plurality of features TO extracted by the extraction unit CY, more specifically, for example, on the basis of the number and positions of the plurality of features TO.

The increasing unit ZO increases the number of the cameras KAa, KAb and the like depending on results of the evaluation of the plurality of images GA by the evaluation unit HY.

The repetition unit KU repeats the change in positions of the cameras KAa, KAb and the like by the arrangement unit HA, the imaging of the model object MO by the imaging unit SA, the extraction of the plurality of features TO by the extraction unit CY, the evaluation of the plurality of images GA by the evaluation unit HY, and the increase in the number of the cameras KAa, KAb and the like by the increasing unit ZO.

The determination unit KT determines the number and positions of the cameras KAa, KAb and the like required to acquire the plurality of images GA regarding the model object MO required to generate the three-dimensional model of the model object MO, through repetition by the repetition unit KU.

The planning unit KK plans, on the basis of the number and positions of the cameras KAa, KAb and the like determined by the determination unit KT, the number and positions of actual cameras KMa, KMb and the like (illustrated in FIG. 2) required to acquire a plurality of actual images GZ (illustrated in FIG. 2) regarding the solid object RI that are to be required to generate the three-dimensional model of the solid object RI.

Hereinafter, the actual image GZ is abbreviated as an “image GZ”, and the actual cameras KMa, KMb and the like are abbreviated as “cameras KMa, KMb, and the like”, for example.

### <Hardware Configuration of First Embodiment>

FIG. 5 illustrates a hardware configuration of the imaging planning device SKS of the first embodiment.

The imaging planning device SKS of the first embodiment includes a processor PR, a memory ME, and a storage medium KI, and further includes an input unit NY and an output unit SY as necessary as illustrated in FIG. 5, in order to perform the above-described function.

The processor PR is a well-known core of a computer that operates hardware in accordance with software.

The memory ME includes, for example, a dynamic random access memory (DRAM) and a static random access memory (SRAM).

The storage medium KI includes, for example, a hard disk drive (HDD), a solid state drive (SSD), and a read only memory (ROM). The storage medium KI stores a program PRG and a database DB.

The program PRG is a command group that defines contents of processing that should be executed by the processor PR.

The database DB captures a wide variety of model objects MO (for example, illustrated in FIG. 3) and a wide variety of solid figures RZ (for example, illustrated in FIG. 4) from a computer network (not illustrated), for example, to store. For example, the database DB stores the model object MO (illustrated in FIG. 3) that imitates a shape of the Kachidoki Bridge regarding the solid object RI, which is the Kachidoki Bridge (illustrated in FIG. 3).

The input unit NY includes, for example, a camera, a microphone, a keyboard, a mouse, and a touch panel. The output unit SY includes, for example, a liquid crystal monitor, a printer, and a touch panel.

Regarding a relationship between the function and the hardware configuration in the imaging planning device SKS, on the hardware, the processor PR implements the function of each of the application unit TE to the planning unit KK by executing the program PRG stored in the storage medium KI on the memory ME and controlling operations of the input unit NY and the output unit SY as necessary.

### <Operation of First Embodiment>

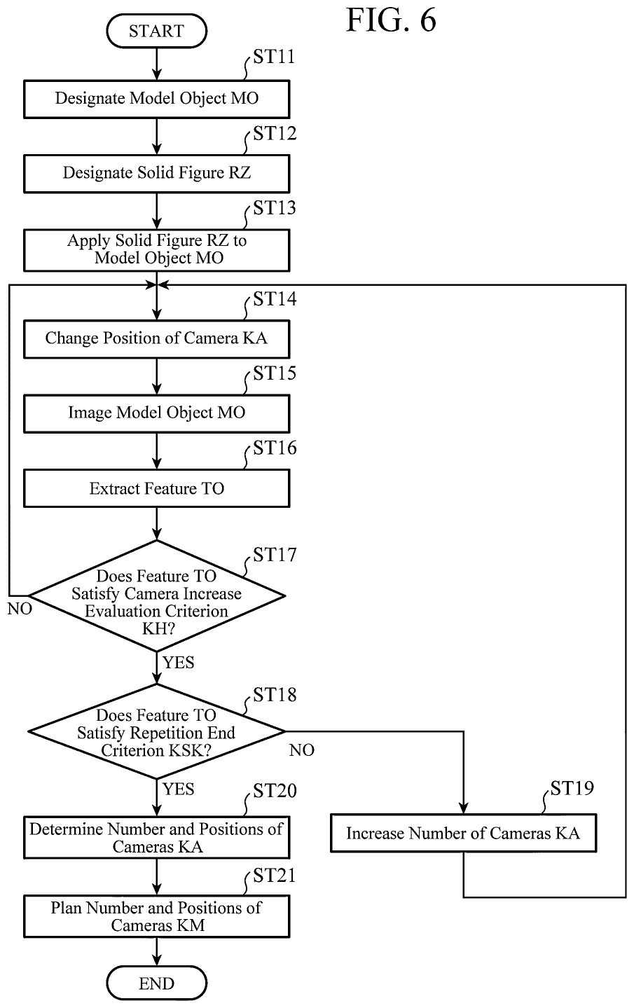

FIG. 6 is a flowchart illustrating an operation of the imaging planning device SKS of the first embodiment.

FIG. 7 illustrates an operation of applying the solid figure RZ to the model object MO of the first embodiment.

FIGS. 8 to 12 illustrate operations of arranging, imaging, and extracting in the imaging planning device SKS of the first embodiment.

The operation of the imaging planning device SKS of the first embodiment will be described with reference to FIGS. 6 to 12.

Hereinafter, in order to facilitate description and understanding, it is assumed that an initial value of the number of the cameras KAa, KAb and the like is “2”.

Although an orthogonal coordinate system is used in the description, a polar coordinate system may be similarly used in place of the orthogonal coordinate system.

Step ST11: When trying to generate the three-dimensional model of the solid object RI (for example, the bridge illustrated in FIG. 2), a user US (not illustrated) of the imaging planning device SKS designates the model object MO that is extracted (illustrated in FIG. 3) by searching the database DB, for example.

Step ST12: The user US designates the solid figure RZ (illustrated in FIG. 4) that will be suitable for the above-described designated model object MO by searching the database DB.

Step ST13: The application unit TE applies the solid figure RZ designated by the user US to the model object MO designated by the user US as illustrated in FIG. 7. More specifically, the application unit TE locates the model object MO inside the solid figure RZ as illustrated in FIG. 7.

### <Two Cameras & First Arrangement>

Step ST14: The arrangement unit HA arranges the cameras KAa and KAb on the basis of the position on the surface of the solid figure RZ. For example, the arrangement unit HA arranges the camera KAa at a position P1a (X1a, Y1a, Z1a) as an initial value on the surface of the solid figure RZ as illustrated in FIG. 8, for example.

The arrangement unit HA similarly arranges the camera KAb at a position P1b (X1b, Y1b, Z1b) as an initial value on the surface of the solid figure RZ as illustrated in FIG. 8, for example.

Herein, in place of the positions on the surface of the solid figure RZ as described above, the positions P1a and P1b may be positions above the surface of the solid figure RZ, that is, positions farther from an origin O (illustrated in FIG. 4), or positions below the surface of the solid figure RZ, that is, positions closer to the origin O.

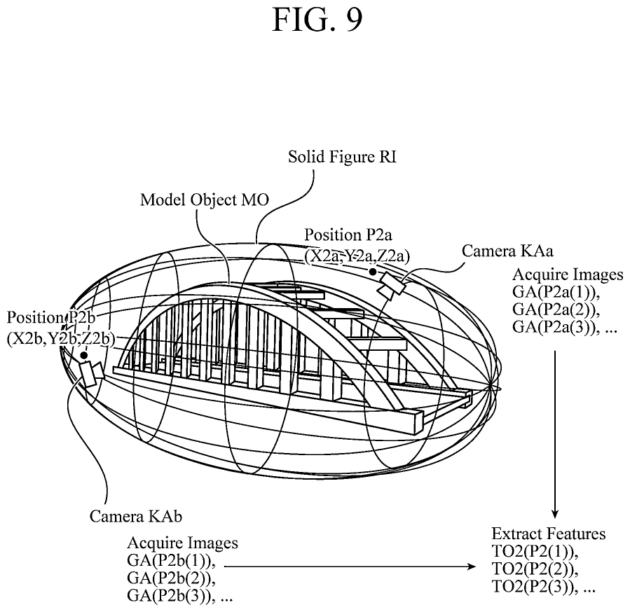

The same applies to other positions, for example, P2a, P2b and the like (for example, illustrated in FIG. 9).

Step ST15: The imaging unit SA acquires images GA(P1a(1)), (P1a(2)), (P1a(3)), . . . as illustrated in FIG. 8, by imaging the model object MO using the camera KAa arranged at the position P1a. The imaging unit SA similarly acquires images GA(P1b(1)), (P1b(2)), (P1b(3)), . . . as illustrated in FIG. 8, by imaging the model object MO using the camera KAb arranged at the position P1b.

Step ST16: The extraction unit CY extracts the features TO of the model object MO from the acquired images GA(P1a(1)), (P1a(2)), (P1a(3)), . . . , and GA(P1b(1)), (P1b(2)), (P1b(3)), . . . as illustrated in FIG. 8, by a method similar to the conventionally known method. Herein, as illustrated in FIG. 8, for example, it is assumed that features TO2(P1(1)), TO2(P1(2)), TO2(P1(3)), . . . of the model object MO are extracted.

Herein, the number “2” after TO means that the feature TO is extracted from the images GA imaged by the two cameras KA. The same applies to other numbers, for example, “3” and the like.

Step ST17: The evaluation unit HY evaluates whether the extracted features TO2(P1(1)), TO2(P1(2)), TO2(P1(3)), . . . satisfy an evaluation criterion (hereinafter, referred to as a “camera increase evaluation criterion KH”) serving as a criterion for determining whether to increase the number of the cameras KA.

The camera increase evaluation criterion KH is, for example, a threshold (the lower limit value) of the predetermined number of the features TO that should be extracted, and is the maximum value (the upper limit value) of the number of the features TO expected to be extracted, under the condition of the number of the cameras KA used for imaging the model object MO.

When the extracted features TO do not satisfy the camera increase evaluation criterion KH, the processing returns to step ST14, and in contrast, when the extracted features TO satisfy the camera increase evaluation criterion KH, the processing proceeds to step ST18.

Herein, it is assumed that the extracted features TO2(P1(1)), TO2(P1(2)), TO2(P1(3)), . . . do not satisfy the camera increase evaluation criterion KH, and the processing returns to step ST14.

### <Two Cameras & Second Arrangement>

Step ST14: The arrangement unit HA arranges the camera KAa at a position P2a (X2a, Y2a, Z2a) different from the position P1a (illustrated in FIG. 8) as illustrated in FIG. 9. The arrangement unit HA similarly arranges the camera KAb at a position P2b (X2b, Y2b, Z2b) different from the position P1b (illustrated in FIG. 8) as illustrated in FIG. 9.

Step ST15: The imaging unit SA acquires images GA(P2a(1)), (P2a(2)), (P2a(3)), . . . , and images GA(P2b(1)), (P2b(2)), (P2b(3)), . . . as illustrated in FIG. 9, by imaging the model object MO using the camera KAa arranged at the position P2a and the camera KAb arranged at the position P2b.

Step ST16: The extraction unit CY extracts the features TO of the model object MO from the acquired images GA(P2a(1)), (P2a(2)), (P2a(3)), . . . , and the images GA(P2b(1)), (P2b(2)), (P2b(3)), . . . as illustrated in FIG. 9. Herein, for example, it is assumed that features TO2(P2(1)), TO2(P2(2)), TO2(P2(3)), . . . of the model object MO are extracted.

Step ST17: The evaluation unit HY evaluates whether the features TO2(P1(1)), TO2(P1(2)), TO2(P1(3)), . . . , and TO2(P2(1)), TO2(P2(2)), TO2(P2(3)), . . . extracted so far satisfy the camera increase evaluation criterion KH.

Herein, it is assumed that the features TO2(P1(1)), TO2(P1(2)), TO2(P1(3)), . . . , and TO2(P2(1)), TO2(P2(2)), TO2(P2(3)), . . . extracted so far do not satisfy the camera increase evaluation criterion KH, and the processing returns to step ST14.

### <Two Cameras & Third Arrangement>

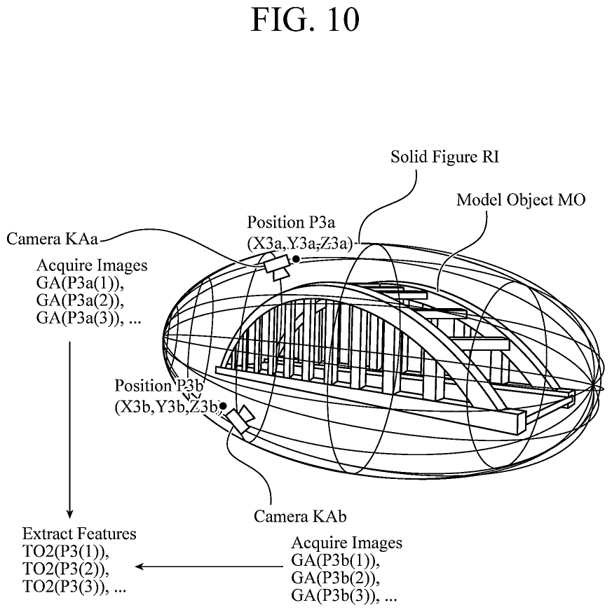

Step ST14: The arrangement unit HA arranges the camera KAa at a position P3a (X3a, Y3a, Z3a) different from the position P1a (illustrated in FIG. 8) and the position P2a (illustrated in FIG. 9) as illustrated in FIG. 10. The arrangement unit HA similarly arranges the camera KAb at a position P3b (X3b, Y3b, Z3b) different from the position P1b (illustrated in FIG. 8) and the position P2b (illustrated in FIG. 9) as illustrated in FIG. 10.

Step ST15: The imaging unit SA acquires images GA(P3a(1)), (P3a(2)), (P3a(3)), . . . , and images GA(P3b(1)), (P3b(2)), (P3b(3)), . . . as illustrated in FIG. 10, by imaging the model object MO using the camera KAa arranged at the position P3a and the camera KAb arranged at the position P3b.

Step ST16: The extraction unit CY extracts the features TO of the model object MO from the acquired images GA(P3a(1)), (P3a(2)), (P3a(3)), . . . , and the images GA(P3b(1)), (P3b(2)), (P3b(3)), . . . as illustrated in FIG. 10. Herein, for example, it is assumed that features TO2(P3(1)), TO2(P3(2)), TO2(P3(3)), . . . of the model object MO are extracted.

Step ST17: The evaluation unit HY evaluates whether the features TO2(P1(1)), TO2(P1(2)), TO2(P1(3)), . . . , TO2(P2(1)), TO2(P2(2)), TO2(P2(3)), . . . , and TO2(P3(1)), TO2(P3(2)), TO2(P3(3)), . . . extracted so far satisfy the camera increase evaluation criterion KH.

Herein, it is assumed that the features TO2(P1(1)), TO2(P1(2)), TO2(P1(3)), . . . , TO2(P2(1)), TO2(P2(2)), TO2(P2(3)), . . . , and TO2(P3(1)), TO2(P3(2)), TO2(P3(3)), . . . extracted so far satisfy the camera increase evaluation criterion KH, and the processing proceeds to step ST18.

### <Determination of Repetition End Criterion>

Step ST18: The repetition unit KU determines whether the features TO2(P1(1)), TO2(P1(2)), TO2(P1(3)), . . . , TO2(P2(1)), TO2(P2(2)), TO2(P2(3)), . . . , and TO2(P3(1)), TO2(P3(2)), TO2(P3(3)), . . . extracted so far satisfy a determination criterion of whether the repetition by the repetition unit KU can be ended (hereinafter, referred to as “repetition end criterion KSK”).

The repetition end criterion KSK is, for example, the number and positions of the features TO required to generate the three-dimensional model of the model object MO.

When the extracted features TO do not satisfy the repetition end criterion KSK, the processing returns to step ST14 via step ST19, and on the other hand, when the extracted features TO satisfy the repetition end criterion KSK, the processing proceeds to step ST20.

Herein, it is assumed that the features TO2(P1(1)), TO2(P1(2)), TO2(P1(3)), . . . , TO2(P2(1)), TO2(P2(2)), TO2(P2(3)), . . . , and TO2(P3(1)), TO2(P3(2)), TO2(P3(3)), . . . extracted so far do not satisfy the repetition end criterion KSK, and the processing returns to step ST14 via step ST19.

<Increase from Two Cameras to Three Cameras>

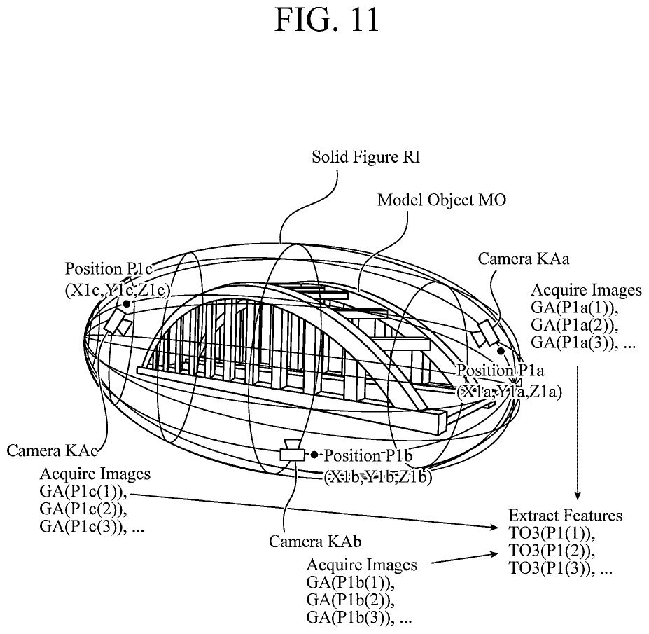

Step ST19: The increasing unit ZO increases the number of the cameras KAa and KAb by one, that is, cameras KAa, KAb, and KAc are obtained (the camera KAc is illustrated in FIG. 11, for example).

### <Three Cameras & First Arrangement>

Step ST14: The arrangement unit HA arranges the cameras KAa and KAb at positions P1a (X1a, Y1a, Z1a) and P1b (X1b, Y1b, Z1b) (similar to the positions P1a and P1b illustrated in FIG. 8) as the initial values, respectively, and arranges the camera KAc at a position P1c (X1c, Y1c, Z1c) as an initial value as illustrated in FIG. 11.

Step ST15: The imaging unit SA acquires the images GA(P1a(1)), (P1a(2)), (P1a(3)), . . . , the images GA(P1b(1)), (P1b(2)), (P1b(3)), . . . , and images GA(P1c(1)), (P1c(2)), (P1c(3)), . . . as illustrated in FIG. 11, by imaging the model object MO using the cameras KAa, KAb, and KAc arranged at the positions P1a, P1b, and P1c, respectively.

Step ST16: The extraction unit CY extracts the features TO of the model object MO from the acquired images GA(P1a(1)), (P1a(2)), (P1a(3)), . . . , the images GA(P1b(1)), (P1b(2)), (P1b(3)), . . . , and the images GA(P1c(1)), (P1c(2)), (P1c(3)) as illustrated in FIG. 11. Herein, for example, it is assumed that features TO3(P1(1)), TO3(P1(2)), TO3(P1(3)), . . . of the model object MO are extracted.

Step ST17: The evaluation unit HY evaluates whether the extracted features TO3(P1(1)), TO3(P1(2)), TO3(P1(3)), . . . satisfy the camera increase evaluation criterion KH.

Herein, it is assumed that the extracted features TO3(P1(1)), TO3(P1(2)), TO3(P1(3)), . . . do not satisfy the camera increase evaluation criterion KH, and the processing returns to step ST14.

### <Three Cameras & Second Arrangement>

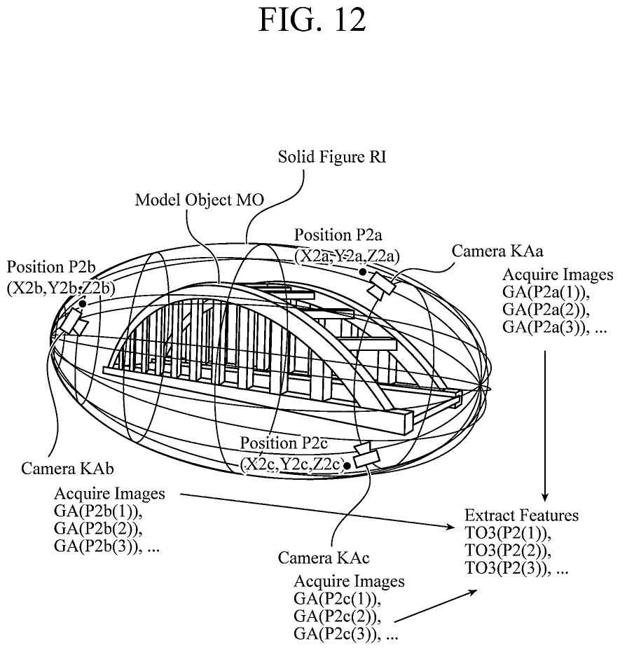

Step ST14: The arrangement unit HA arranges the cameras KAa, KAb, and KAc at a position P2a (X2a, Y2a, Z2a) different from the position P1a (illustrated in FIG. 11), a position P2b (X2b, Y2b, Z2b) different from the position P1b (illustrated in FIG. 11), and a position P2c (X2c, Y2c, Z2c) different from the position P1c (illustrated in FIG. 11) as illustrated in FIG. 12.

Step ST15: The imaging unit SA acquires the images GA(P2a(1)), (P2a(2)), (P2a(3)), . . . , the images GA(P2b(1)), (P2b(2)), (P2b(3)), . . . , and images GA(P2c (1)), (P2c (2)), (P2c (3)), . . . as illustrated in FIG. 12, by imaging the model object MO using the cameras KAa, KAb, and KAc arranged at the positions P2a, P2b, and P2c, respectively.

Step ST16: The extraction unit CY extracts the features TO of the model object MO from the acquired images GA(P2a(1)), (P2a(2)), (P2a(3)), the images GA(P2b(1)), (P2b(2)), (P2b(3)), . . . , and the images GA(P2c (1)), (P2c (2)), (P2c (3)) as illustrated in FIG. 11. Herein, for example, it is assumed that features TO3(P2(1)), TO3(P2(2)), TO3(P2(3)), . . . of the model object MO are extracted.

Step ST17: The evaluation unit HY evaluates whether the features TO3(P1(1)), TO3(P1(2)), TO3(P1(3)), . . . , and TO3(P2(1)), TO3(P2(2)), TO3(P1(3)), . . . extracted so far satisfy the camera increase evaluation criterion KH.

Herein, it is assumed that the features TO3(P1(1)), TO3(P1(2)), TO3(P1(3)), . . . , and TO3(P2(1)), TO3(P2(2)), TO3(P2(3)), . . . extracted so far satisfy the camera increase evaluation criterion KH, and the processing proceeds to step ST18.

Step ST18: The repetition unit KU determines whether all the features TO2(P1(1)), TO2(P1(2)), TO2(P1(3)), . . . , TO2(P2(1)), TO2(P2(2)), TO2(P2(3)), . . . , TO2(P3(1)), TO2(P3(2)), TO2(P3(3)), . . . , TO3(P1(1)), TO3(P1(2)), TO3(P1(3)), . . . , and TO3(P2(1)), TO3(P2(2)), TO3(P2(3)), . . . extracted so far satisfy the repetition end criterion KSK.

Herein, it is assumed that all the features TO extracted so far described above satisfy the repetition end criterion KSK, and the processing proceeds to step ST20.

Step ST20: The determination unit KT determines that the number and positions of the cameras KA required to acquire the images GA required to generate the three-dimensional model of the model object MO are the number “3” and positions “P1a to P2a, P1b to P2b, and P1c to P2c”, respectively.

Step ST21: The planning unit KK determines, on the basis of the number “3” and positions “P1a to P2a, P1b to P2b, and P1c to P2c” of the cameras KA determined by the determination unit KT, the number and positions of the cameras KM required to acquire the image GZ (illustrated in FIG. 2) regarding the solid object RI that are to be required to generate the three-dimensional model of the solid object RI (illustrated in FIG. 2) as the number “3” and positions “P1a to P2a, P1b to P2b, and P1c to P2c”, respectively.

### Effect of First Embodiment

As described above, in the imaging planning device SKS of the first embodiment, the repetition unit KU basically repeats the change in position of the camera KA and the acquisition of the image GA on the basis of the position on the surface of the solid figure RZ applied to the model object MO. The determination unit KT determines the number and positions of the cameras KA required to acquire the images GA for generating the three-dimensional model of the model object MO from the result of the repetition. The planning unit KK plans the number and positions of the cameras KM that are to be required to acquire the images GZ for generating the three-dimensional model of the solid object RI on the basis of the determination by the determination unit KT. As a result, it is possible to plan estimation of a pose of the camera for additional imaging performed to complete the three-dimensional model, with higher accuracy.

### Second Embodiment

### Second Embodiment

An imaging planning device SKS of a second embodiment will be described.

### <Function of Second Embodiment>

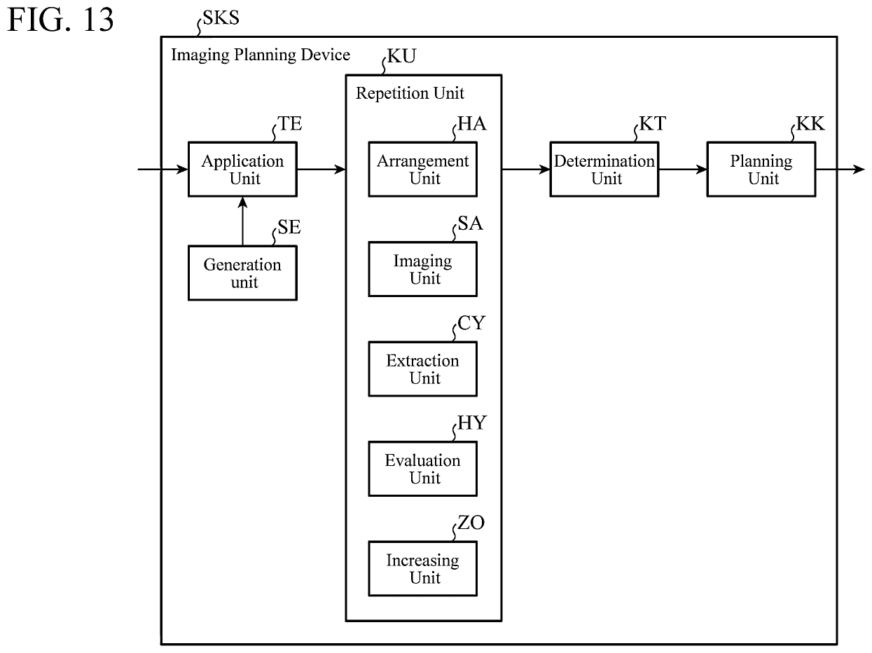

FIG. 13 is a functional block diagram of the imaging planning device SKS of the second embodiment.

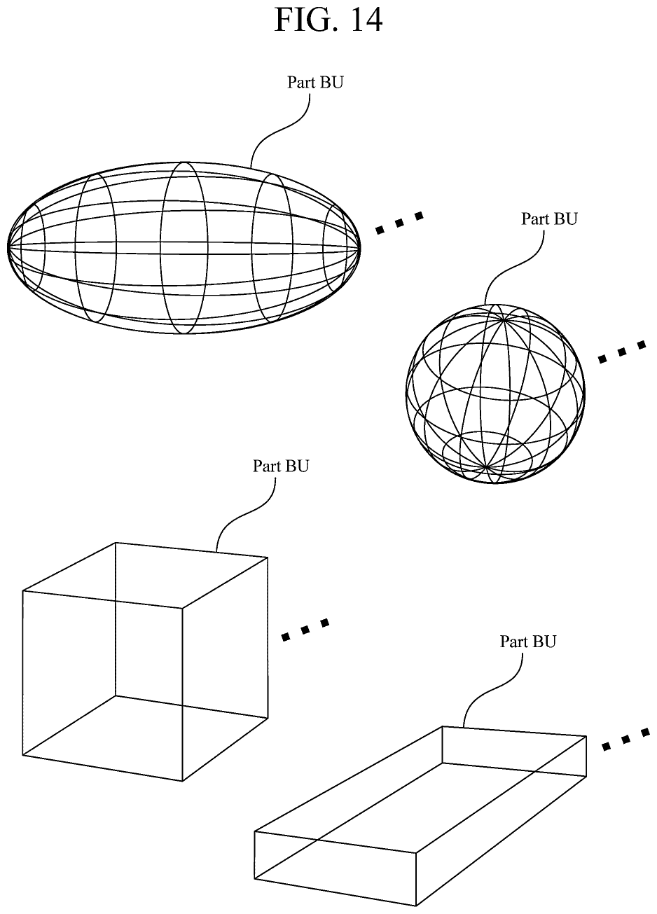

FIG. 14 illustrates a virtual part BU of the second embodiment.

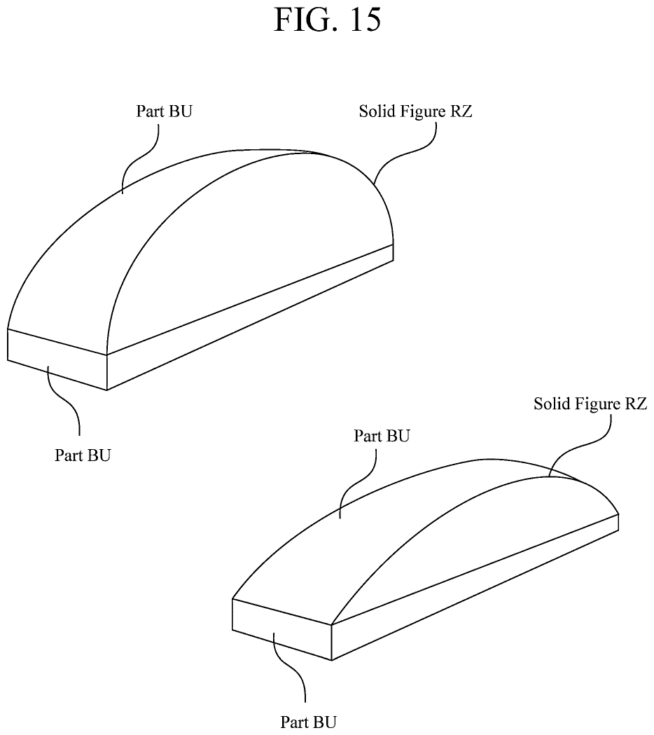

FIG. 15 illustrates a solid figure RZ of the second embodiment.

The imaging planning device SKS of the second embodiment will be described with reference to FIGS. 13 to 15.

As is clear from comparison between FIG. 13 and FIG. 1 (the imaging planning device SKS of the first embodiment), the imaging planning device SKS of the second embodiment basically has a function similar to the function of the imaging planning device SKS of the first embodiment.

On the other hand, the imaging planning device SKS of the second embodiment is different from the imaging planning device SKS of the first embodiment, and further includes a generation unit SE as illustrated in FIG. 13.

The generation unit SE generates a solid figure RZ (illustrated in FIG. 15) by combining some virtual parts BU out of a plurality of virtual parts BU (illustrated in FIG. 14) that can be used for forming the solid figure RZ (for example, illustrated in FIGS. 4 and 15).

Hereinafter, the virtual part BU is abbreviated as a “part BU”.

The parts BU have different shapes from each other such as an ellipsoid, a sphere, a cube, or a rectangular parallelepiped, for example, as illustrated in FIG. 14. Similarly to the solid figure RZ, the part BU is present on a computer or a computer network, and is stored, for example, in a database DB (illustrated in FIG. 5) of a storage medium KI.

As illustrated in FIG. 15, the solid figure RZ generated by the generation unit SE has a complicated shape as compared with the solid figure RZ (illustrated in FIG. 4) of the first embodiment, and more precisely, has a shape closer to the shape of the model object MO (illustrated in FIG. 3).

The application unit TE applies the solid figure RZ generated by the generation unit SE to the model object MO designated by a user US.

### <Hardware Configuration of Second Embodiment>

A hardware configuration of the imaging planning device SKS of the second embodiment is similar to the hardware configuration of the imaging planning device SKS of the first embodiment (illustrated in FIG. 5).

### <Operation of Second Embodiment>

An operation of the second embodiment is basically similar to the operation of the first embodiment (illustrated in FIG. 6).

On the other hand, in the operation of the second embodiment, unlike the operation of the first embodiment, at step ST12 following step ST11 of the first embodiment, instead of designating the solid figure RZ by the user US, the generation unit SE generates the solid figure RZ (illustrated in FIG. 15) in response to, for example, an instruction of “Generate solid figure RZ using part BU.” from the user US.

At step ST13 following step ST12, as described above, the application unit TE applies the solid figure RZ (illustrated in FIG. 15) generated by the generation unit SE at step ST12 to the model object MO designated by the user US at step ST11.

After step ST13, processing similar to that at step ST14 of the first embodiment is executed.

### Effect of Second Embodiment

As described above, in the imaging planning device SKS of the second embodiment, at step ST12, the generation unit SE generates the solid figure RZ (illustrated in FIG. 15) having a shape closer to the shape of the model object MO (for example, illustrated in FIG. 3) by comparison with the solid figure RZ (illustrated in FIG. 4) of the first embodiment using the part BU (illustrated in FIG. 14), and at step ST13, the application unit TE applies the solid figure RZ (illustrated in FIG. 15) to the model object MO. As a result, a time required for the determination by the determination unit KT and the planning by the planning unit KK to be completed through the repetition by the repetition unit KU after step ST14 can be shortened as compared with required time of the first embodiment.

### Third Embodiment

### Third Embodiment

An imaging planning device SKS of a third embodiment will be described.

In the imaging planning device SKS of the third embodiment, different from the imaging planning device SKS of the first embodiment in which the repetition unit KU increases the number of the cameras KAa, KAb and the like (for example, illustrated in FIG. 7) by one, a repetition unit KU increases the number of cameras KAa, KAb and the like on the basis of binary search.

### <Function and Hardware Configuration of Third Embodiment>

A function and a hardware configuration of the imaging planning device SKS of the third embodiment are basically similar to the function and the hardware configuration of the imaging planning device SKS of the first embodiment (illustrated in FIGS. 1 and 5).

In the imaging planning device SKS of the third embodiment, unlike the function of the imaging planning device SKS of the first embodiment, as described above, the repetition unit KU has a function of increasing the number of the cameras KAa, KAb and the like on the basis of the binary search, and more specifically, for example, setting the number at a median value by the binary search on the basis of the minimum number of the cameras KMa, KMb and the like (illustrated in FIG. 2) for imaging the solid object RI (illustrated in FIG. 2) that should be prepared and the maximum number of the cameras KMa, KMb and the like that may be prepared as an initial value of the number of the cameras KAa, KAb and the like, and then repeating steps ST14 to ST19.

### Operation of Third Embodiment

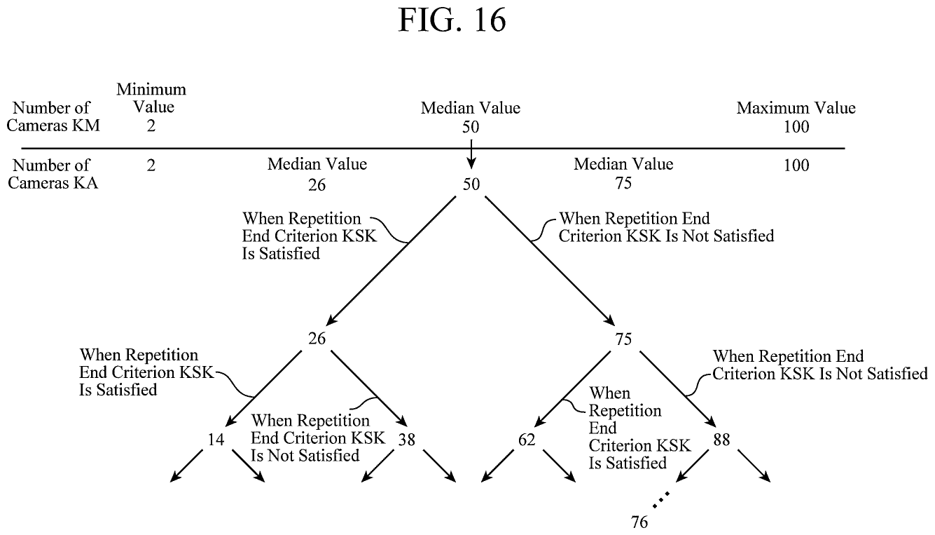

FIG. 16 illustrates an operation of the imaging planning device SKS of the third embodiment.

The operation of the imaging planning device SKS of the third embodiment is basically similar to that of the imaging planning device SKS of the first embodiment except that the number of the cameras KA is increased or decreased on the basis of the binary search. Therefore, the operation of the imaging planning device SKS of the third embodiment will be described with reference to FIGS. 16 and 6 (the flowchart illustrating the operation of the imaging planning device SKS of the first embodiment).

Hereinafter, in order to facilitate the description and understanding, as illustrated in FIG. 16, it is assumed that the minimum number of cameras KM that should be prepared for imaging the solid object RI is “2” and the maximum number of cameras KM that can be prepared is “100”.

The repetition unit KU sets the initial value of the number of the cameras KA for imaging the model object MO to the median value “50” of the minimum value “2” and the maximum value “100” on the basis of the binary search as illustrated in FIG. 16.

After the above-described setting, the repetition unit KU repeats steps ST14 to ST17 (illustrated in FIG. 6).

At steps ST18 and ST19, as a result of the repetition described above, for example, when extracted features TO50(P1(1)), TO50(P1(2), TO50(P1(3)), . . . , TO50(P2(1)), TO50(P2(2), TO50(P2(3)), . . . , TO50(P3(1)), TO50(P3(2), TO50(P3(3)), . . . and the like (not illustrated) satisfy a repetition end criterion KSK, the repetition unit KU decreases the number of the cameras KA from “50” to “26” (the median value between the minimum value “2” and “50”), and on the other hand, when they do not satisfy the repetition end criterion KSK, this increases the number of the cameras KA from “50” to “75” (the median value between “50” and the maximum value “100”).

For example, after decreasing the number of the cameras KA from “50” to “26” and repeating steps ST14 to ST17 in the manner similar to that described above, when the result of the repetition satisfies the repetition end criterion KSK at steps ST18 and ST19, the repetition unit KU decreases the number of the cameras KA from “26” to “14” as illustrated in FIG. 16, and on the other hand, when the result does not satisfy the repetition end criterion KSK, this increases the number of the cameras KA from “26” to “38”.

Unlike the description above, after increasing the number of the cameras KA from “50” to “75” and repeating steps ST14 to ST17 in the manner similar to that described above, when the result of the repetition satisfies the repetition end criterion KSK at steps ST18 and ST19, the repetition unit KU decreases the number of the cameras KA from “75” to “62”, and on the other hand, when the result does not satisfy the repetition end criterion KSK, this increases the number of the cameras KA from “75” to “88”.

Since the repetition unit KU increases or decreases the number of the cameras KA on the basis of the binary search, for example, without repeating steps ST14 to ST17 “74 times” as in the case of the imaging planning device SKS of the first embodiment, at step ST20, the planning unit KK plans that the number of the cameras KM required to acquire the plurality of images GZ regarding the solid object RI is “76” as illustrated in FIG. 16.

### Effect of Third Embodiment

As described above, in the imaging planning device SKS of the third embodiment, the repetition unit KU increases or decreases the number of the cameras KA on the basis of the binary search, so that the time required for the planning unit KK to plan the number of the cameras KM required to acquire the plurality of images GZ regarding the solid object RI can be shortened as compared with the imaging planning device SKS of the first embodiment.

The above-described embodiments may be combined, and components in each embodiment may be appropriately eliminated or changed, or other components may be added without departing from the gist of the present disclosure.

### INDUSTRIAL APPLICABILITY

The present disclosure can be used to suppress prolongation of a time required for completing the three-dimensional model according to the present disclosure.

### REFERENCE SIGNS LIST

BU: part, CY: extraction unit, GA: image, GZ: image, HA: arrangement unit, HY: evaluation unit, KA: camera, KI: storage medium, KK: planning unit, KM: camera, KT: determination unit, KU: repetition unit, ME: memory, MO: model object, NY: input unit, PR: processor, PRG: program, RI: solid object, RZ: solid figure, SA: imaging unit, SE: generation unit, SKS: imaging planning device, SY: output unit, TE: application unit, TO: feature, US: user, ZO: increasing unit

1. An imaging planning device comprising processing circuitry
to apply a virtual solid figure having a predetermined shape to a virtual model object imitating a shape of a solid object for which a three-dimensional model is to be generated,
to perform repetition of arrangement of a position of at least one virtual camera on a basis of a position on a surface of the virtual solid figure, imaging of the virtual model object by the at least one virtual camera at a position after the arrangement, and an increase in the number of the at least one virtual camera,
to determine the number and positions of the at least one virtual camera required to acquire a plurality of virtual images regarding the virtual model object required to generate a three-dimensional model of the virtual model object obtained by the repetition, and
to plan, on a basis of the number and the positions of the at least one virtual camera, the number and positions of cameras required to acquire a plurality of images regarding the solid object that are to be required to generate the three-dimensional model of the solid object.

2. The imaging planning device according to claim 1, wherein the processing circuitry further generates the virtual solid figure by combining at least one virtual part out of a plurality of virtual parts that can be used to form the virtual solid figure.

3. The imaging planning device according to claim 1, wherein the processing circuitry further sets the number of cameras determined on a basis of a minimum number of the cameras to be prepared and a maximum number of the cameras that can be prepared as an initial value of the number of the at least one virtual camera instead of the increase in the number of the at least one virtual camera, and then increases or decreases the number of the at least one virtual camera on a basis of binary search.

4. An imaging planning method comprising:
applying a virtual solid figure having a predetermined shape to a virtual model object imitating a shape of a solid object for which a three-dimensional model is to be generated;
performing repetition of arrangement of a position of at least one virtual camera on a basis of a position on a surface of the virtual solid figure, imaging of the virtual model object by the at least one virtual camera at a position after the arrangement, and an increase in the number of the at least one virtual camera;
determining the number and positions of the at least one virtual camera required to acquire a plurality of virtual images regarding the virtual model object required to generate a three-dimensional model of the virtual model object obtained by the repetition; and
planning on a basis of the number and the positions of the at least one virtual camera the number and positions of cameras required to acquire a plurality of images regarding the solid object that are to be required to generate the three-dimensional model of the solid object.
